(19) United States
(12) Patent Application Publication
(10) Pub. No.: US 2015/0242583 A1
(43) Pub. Date: Aug. 27, 2015

(54) Online Health Service Program, Systems, and Methods

(71) Applicant: Brad Edson, Scottsdale, AZ (US)

(72) Inventor: Brad Edson, Scottsdale, AZ (US)

(73) Assignee: Stat Health Services, Inc., Scottsdale, AZ (US)

(21) Appl. No.: 14/331,378

(22) Filed: Jul. 15, 2014

Related U.S. Application Data
(60) Provisional application No. 61/945,014, filed on Feb. 26, 2014.

(51) Int. Cl. G06F 19/00

(52) U.S. Cl. CPC G06F 19/3418; G06F 19/322; G06F 19/345

(57) ABSTRACT

An online medical program, systems, and methods for providing improved health care delivery, diagnosis, consultation, and treatment. The system involves the ability for a health care provider to prescribe medication. The system allows for transfer of medical information, records and data to health service providers and allows them access and evaluation of the information and/or data. Further the program allows for interactive audio, visual, data communication and storage of medical information between patient and health care provider in proprietary web based storage facilities. The system may allow for medical consultation with physicians for minor medical conditions while providing a cost-effective, convenient and medically acceptable alternative to an in person visit at an urgent care center or medical center, especially in the event of unavailability of a primary physician. The online medical system may be affiliated with health insurance groups such that the health insurance group may be responsible for payment for the consultations, treatments and other procedures incurred by the individual patient utilizing the online program and system.

### CROSS-REFERENCE REFERENCE TO RELATED APPLICATION(S)

This document is a non-provisional patent application which claims priority to, and the benefit of, U.S. Provisional Patent Application Ser. No. 61/945,014, filed on Feb. 26, 2014, entitled “ONLINE HEALTH SERVICE PROGRAM AND SYSTEM,” which is herein incorporated by reference in its entirety for all purposes.

### TECHNICAL FIELD

The present disclosure technically relates online health service programs and systems. More specifically, the present disclosure technically relates to an online system and program for the consultation and diagnosis of a medical condition by a physician from a remote location.

### BACKGROUND

Networking and online search systems have become important ways for interacting, sharing experiences, and gathering information. Historically, networking and, more specifically, health information has been predicated on a geographical location and access to health care individuals.

With the advent of the Internet, information and resources may be available to the public any time they have access to the Internet. A person desiring information on any matter may simply perform an online search request and obtain responses to their query within a very short time period. However, the need for support and experience requires an online site that provides information and resources for these queries.

Many related art online networking and educational sites exist that provide online factual information, such as numerous social networking sites that provide services to connect individuals for any number of purposes. Also, related art online health sites exist that provide information about various health concerns and articles relating to health studies. These related art online health sites provide general information about specific medical conditions, but these related art online health sites do not provide the medical expertise, or medical advice, that would otherwise be provided by a professional health care service provider.

However, with respect to health-related online medical-, or health-, related programs and systems, the resources are much more limited, because maintaining the privacy of medically-related information and privately discussing medical conditions with a physician are desirable. Individuals that suffer from specific minor ailments or injuries are forced to either seek medical attention at a health care facility or to seek general information from Internet websites relating to health issues. These related art general health-related websites provide information about specific ailments and medical conditions, but these related art sites cannot analyze whether the conditions apply to a certain patient or individual.

Moreover, these related art general health websites do not relate information, such as frequency of specific medical conditions. As such, many patients are mistakenly convinced that they have a specific and extremely rare health condition that is not typically diagnosed by a health care provider. However, currently, no related art online health and/or medical systems exist that assist individual patients in discussing and presenting specific medical concerns in an online format.

Therefore, a need exists for an improved online health care system and program. More specifically, a need exists for an improved online health care system and program which assists individuals with specific medical problems and that provides the individual patient with health care delivery, diagnosis, and consultation with a physician. Moreover, a need exists for a system that allows ordering of X-rays and laboratory tests, provides follow-up and treatment, including providing prescriptions for medications and devices.

Additionally, a need exists for an improved online medical/health system and a program which may provide convenient cost-effective and medically equivalent alternatives to an in-person visit at an urgent care center or emergency room. Moreover, the program may provide treatment of common minor medical conditions when the patient's primary care physician is unavailable. Further, a need exists for a cost-efficient online health service which may provide a significant cost savings to the insurance carrier and insured individual, thereby lowering the cost of health insurance premiums. Additionally, a need exists for an efficient health care program and system that allows for online transfer of medical data and online maintenance of medical records such that an online consulted physician has immediate access to an individual's medical record.

### SUMMARY

Various embodiments of the present disclosure involve an improved online medical program, systems, and methods under which health care delivery, diagnosis, consultation, and treatment are provided, including the prescription of medication. The improved medical program, systems, and methods facilitates transfer of, and access to, medical information, records, and data to health care service providers and facilitates evaluation of such medical information, records, and data. Further, the program, such as a software program, facilitates interactive audio, visual, and data communication as well as storage of medical information transmitted between a patient and a health care service provider in proprietary web-based storage facilities. The online medical program, systems, and methods facilitate medical consultations with physicians for minor medical conditions while providing a cost-effective, convenient, and medically-acceptable alternative to an in-person visit at an urgent care center or a medical center, especially in the event that a primary care physician is unavailable. Contemplated is that the online medical program, systems, and methods are affiliated with heath insurance groups, such that a health insurance group, that is responsible for payment of the consultations, treatments, and other procedures incurred by the individual patient is identifiable and even billable.

To this end, in an exemplary embodiment of the present disclosure, an online medical method involves an individual patient utilizing a remote computing station of an online medical system. Contemplated is that the online medical program, systems, and methods involve an Internet based online health service adapted to provide appropriate medical examination for the type of medical condition to be diagnosed and treated. In a method of operation, the user enters at least one criterion into the system, comprising a stored on a remote server that is located at a remote server location. The database on the remote server is adapted to store patient data and information. Additionally, in the method of operation, a physician can be located at a remote location, e.g., a remote physician location, which can be at least one of the same location as the remote server location or a different location from the remote server location, wherein the “same location” denotes the same general location, such as the same address, and wherein the same location does not necessarily denote that the physician is located in a server room, for example. The physician that receives information from the individual patient may respond through the remote server location, whereby information transmitted from the physician is received at the individual patient's remote computing station.

In other exemplary embodiments of the present disclosure, an online medical system, the system comprising: at least one database storable in relation to at least one remote server, the at least one database capable of storing at least one of patient information and physician information, the patient information comprising at least one of patient data, patient medical records, and patient input criteria, and the physician information comprising at least one of physician data, physician track records, physician feedback, and physician orders; and at least one set of executable instructions storable in relation to the at least one remote server and operable in relation to the at least one database, the at least one remote server disposed in relation to at least one remote server location, and the at least one set of executable instructions capable of facilitating a virtual medical consultation.

In an exemplary embodiment, wherein the at least one set of executable instructions facilitates communication between the at least one remote server and at least one of at least one remote patient and at least one remote physician, and wherein the at least one set of executable instructions facilitates communication between the at least one remote patient and the at least one remote physician.

In an exemplary embodiment, wherein the at least one remote server is capable of communicating with at least one remote patient station disposed in relation to at least one remote patient location, the at least one remote patient station adapted to receive, process, and transmit the patient information to the at least one remote server.

In an exemplary embodiment, wherein the at least one remote server is capable of communicating with at least one remote physician station for facilitating communication by the at least one remote physician disposed in relation to at least one remote physician location for facilitating communication by the at least one remote physician with the remote server, the at least one remote physician station adapted to receive the patient information and to transmit at least one discharge instruction and at least one prescription.

In an exemplary embodiment, wherein the physician feedback comprises information relating to at least one of a diagnosis, a prognosis, a treatment plan, a pharmaceutical prescription, an over-the-counter prescription, a medical device prescription, a medical equipment prescription, and a health enhancement prescription.

In an exemplary embodiment, wherein the database is further capable of maintaining at least one of the patient information and the physician information.

In an exemplary embodiment, wherein the set of executable instructions facilitates communication via at least one mode of an interactive audio mode, a visual mode, any electronic mode, and any digital mode.

In an exemplary embodiment, wherein the set of executable instructions facilitates payment for a consultation by at least one source of the at least one remote patient, at least one health insurance provider, at least one parent, and at least one guardian.

In an exemplary embodiment, wherein the physician orders comprises at least one of a radiology order, a laboratory test order, and a monitoring order specific to the at least one remote patient.

In an exemplary embodiment, wherein the radiology order comprises at least one of an order X-ray order, an MRI scan order, and a CT Scan order.

In an exemplary embodiment, wherein the set of executable instructions facilitates transmitting the patient information from the at least one database to a primary care physician.

In an exemplary embodiment, wherein the set of executable instructions facilitates providing a follow-up virtual consultation.

In an exemplary embodiment, wherein the remote server location and the remote physician location comprise substantially a same location.

In an exemplary embodiment, further comprising: wherein the at least one set of executable instructions facilitates communication between the at least one remote server and at least one of at least one remote patient and at least one remote physician, wherein the at least one set of executable instructions facilitates communication between the at least one remote patient and the at least one remote physician, wherein the at least one remote server is capable of communicating with at least one remote patient station disposed in relation to at least one remote patient location, the at least one remote patient station adapted to receive, process, and transmit the patient information to the at least one remote server, wherein the at least one remote server is capable of communicating with at least one remote physician station for facilitating communication by the at least one remote physician disposed in relation to at least one remote physician location for facilitating communication by the at least one remote physician with the remote server, the at least one remote physician station adapted to receive the patient information and to transmit at least one discharge instruction and at least one prescription, wherein the physician feedback comprises information relating to at least one of a diagnosis, a prognosis, a treatment plan, a pharmaceutical prescription, an over-the-counter prescription, a medical device prescription, a medical equipment prescription, and a health enhancement prescription, wherein the database is further capable of maintaining at least one of the patient information and the physician information, wherein the set of executable instructions facilitates communication via at least one mode of an interactive audio mode, a visual mode, any electronic mode, and any digital mode, wherein the set of executable instructions facilitates payment for a consultation by at least one source of the at least one remote patient, at least one health insurance provider, at least one parent, and at least one guardian, wherein the physician orders comprises at least one of a radiology order, a laboratory test order, and a monitoring order specific to the at least one remote patient, wherein the radiology order comprises at least one of an order X-ray order, an MRI scan order, and a CT Scan order, wherein the set of executable instructions facilitates transmitting the patient information from the at least one database to a primary care physician, wherein the set of executable instructions facilitates providing a follow-up virtual consultation, and wherein the remote server location and the remote physician location comprise substantially a same location.

In another exemplary embodiment, a method of providing an online medical system, the method comprising: providing at least one database storable in relation to at least one remote server, the database providing comprising providing the at least one database as capable of storing at least one of patient information and physician information, the patient information comprising at least one of patient data, patient medical records, and patient input criteria, and the physician information comprising at least one of physician data, physician track records, physician feedback, and physician orders; and providing at least one set of executable instructions storable in relation to the at least one remote server and operable in relation to the at least one database, the at least one remote server disposed in relation to at least one remote server location, and the at least one set of executable instructions capable of facilitating a virtual medical consultation.

In another exemplary embodiment, wherein providing the at least one set of executable instructions comprises providing the at least one set of executable instructions as capable of facilitating communication between the at least one remote server and at least one of at least one remote patient and at least one remote physician, and wherein providing the at least one set of executable instructions comprises providing the at least one set of executable instructions as capable of facilitating communication between the at least one remote patient and the at least one remote physician.

In another exemplary embodiment, a method of virtually consulting by way of an online medical system, the method comprising: providing the online medical system, the system providing comprising: providing at least one database storable in relation to at least one remote server, the database providing comprising providing the at least one database as capable of storing at least one of patient information and physician information, the patient information comprising at least one of patient data, patient medical records, and patient input criteria, and the physician information comprising at least one of physician data, physician track records, physician feedback, and physician orders; and providing at least one set of executable instructions storable in relation to the at least one remote server and operable in relation to the at least one database, the at least one remote server disposed in relation to at least one remote server location, and the at least one set of executable instructions capable of facilitating a virtual medical consultation; prompting an entry of log-in information; receiving log-in information; determining whether a log-in is successful, and if the log-in is successful; prompting an entry of demographic data relating to the at least one patient by rendering a patient information form and a medical record form; and prompting an entry of information relating to at least one medical concern.

In an exemplary embodiment, further comprising: prompting an entry of payment information; and determining whether payment is authorized.

In an exemplary embodiment, further comprising: providing a virtual waiting room; joining the at least one remote physician by way of at least one remote physician station with the at least one remote patient by way of at least one remote patient station; conducting a virtual office visit; providing at least one of the physician feedback and the physician orders; and transmitting a message indicating a conclusion of the virtual consultation session.

In other exemplary embodiments of the present disclosure, the system further comprises a remote physician station located at a remote location, the remote physician station operable by a physician and adapted to facilitate at least one of: providing consultation and diagnosis of minor medical conditions; providing individual treatment for a patient, including prescribing medications and medical devices; maintaining medical records on a database located at a remote location; communicating via interactive audio, visual, and other electronic and digital techniques, e.g., state-of-the-art techniques; receiving payment for consultation by a patient, health insurance providers, and the like ordering individualized X-rays and laboratory tests from a remote location for the patient; transferring medical information from the database to a primary care physician; and providing a follow-up consultation with the patient, thereby minimizing a need for in-person health care at an urgent care facility.

In other exemplary embodiments of the present disclosure, the system further comprises a remote patient station, such as a remote computer station, located at a remote patient location, the remote patient station operable by a patient and adapted to facilitate at least one of: providing online patient registration through a secure website from a remote computer terminal, the secure website configured to receive personal information and insurance information from the patient and to transmit the personal information and the insurance information into a remotely accessible database for storage, wherein the personal information includes a patient's primary care physician, and wherein the secure website is configured to facilitate completing a medical history or updating an existing medical history that is stored in the remote database; providing access the program, such as the software program, without entering any insurance information for facilitating consultation with a physician by providing other payment information, such as credit card information; selecting and confirming a preferred pharmacy and any participating e-health medical group as a cross-coverage medical group or a primary care medical group; providing advanced interactive Internet-based communication technologies to the patient, such as video-conferencing, video-calling, and chatting, to enable better describing an individual medical condition and/or symptoms; providing notification that a physician will contact the patient within sixty (60) minutes for a medical consultation and that the patient will be charged a specified amount as a co-payment for the medical consultation.

In other exemplary embodiments of the present disclosure, the system further comprises a remote emergency or urgent care station located at a remote urgent care or emergency room location, the remote emergency or urgent care station operable by an urgent care physician, or an emergency room physician, and adapted to facilitate at least one of: receiving information from a patient describing symptoms, commonly regarded as indicating the presence of a medical condition that may require immediate in-person medical care, such as chest pains; transmitting an on-line message advising the patient to immediately physically visit an urgent care center or hospital emergency care facility for diagnosis and treatment; initiating an urgent or emergency medical consultation by an urgent or emergency care physician with the individual patient using any of the advanced Internet-based interactive technologies, such as such as video-conferencing, video-calling, and chatting.

In other exemplary embodiments of the present disclosure, the system further comprises at least one of: a feature for facilitating communication with a physician by the patient by way of a telephone call in the event that the patient does not have access to a computing station; a feature for transmitting digital photographs from the patient to the physician, e.g., by e-mail or web-based hand-held devices, to assist the physician in making a diagnosis; a feature for facilitating a user at a remote location, having no access to an in-person physician, receiving medical, diagnostic, and consultation services via a telephone and/or Internet connection; a feature for affiliating businesses and receiving a fee therefor; a feature providing individual patients with assistance and diagnosis of common minor medical conditions, such as allergies, colds, influenza, arthritis, asthma, conjunctivitis or pink eye, ear infections, inflamed or sore throats, minor joint trauma resulting from sprains and strains, including those from sports injuries, sinus and nasal infections, skin inflammations caused by infections resulting from bacteria, blisters, burns, or insect bites, and urinary tract infections. By way of the presently disclosure program, systems, and methods, urgent care or emergency care medical conditions requiring an in-person medical examination may be quickly referred for treatment at an urgent care center or hospital emergency care facility.

In other exemplary embodiments of the present disclosure, the system further comprises at least one of: a feature for facilitating ordering any X-rays or laboratory tests appropriate for the diagnosis through secure electronic communications from the radiologist or laboratory and for transmitting the X-rays and laboratory test results to the ordering physician through secure electronic communications; a feature for providing a an electronic alert in the form of an email or text message to the individual patient that the X-rays or test results have been received by the e-health service and are being reviewed by an e-health physician; a feature for facilitating review of the X-rays or test results by the physician and for initiating a follow-up consultation with the patient using an advanced Internet-based interactive technology, such as video-conferencing, video-calling, chatting, an email communication, or, if the patient does not have access to these advanced technologies, a telephone call; a feature for providing any prescriptions for medications or medical devices by the physician and for transmitting the prescription to the pharmacy or the medical device provider selected by the patient by way of a secure electronic communication; and a feature for creating a digital medical record following each patient medical consultation by the physician, the digital medical record storable in a centralized database as part of the digital medical history maintained for the patient.

Yet other exemplary embodiments of the present disclosure involve a program, systems, and methods, wherein a designated primary care physician for a given patient is notifiable by a notification feature, wherein a copy of each medical record that is created and copies of any X-rays or laboratory test results utilized or diagnosed during the online consultation is sent to the designated primary care physician, e.g., by a secure electronic communication. In yet another exemplary embodiment of the present disclosure, an online medical program and system may be provided, whereby if it is determined in the medical consultation that the patient should be referred to an urgent care center or hospital emergency care facility, the patient will select an urgent care center or hospital emergency care facility for the patient visit and the e-health service will electronically alert the facility of the anticipated arrival of the patient and send the facility by secure electronic transmission a copy of the medical record prepared by the e-health service physician setting forth the diagnosis.

In another exemplary embodiment of the present disclosure, a program, systems, and methods involve a computer-based system and a technology-driven e-health system that align the interests of the health insurers, primary care and cross-coverage physicians, urgent care centers, hospital emergency care facilities, and patients to provide a cost-efficient, convenient and medically-appropriate diagnosis and treatment of many common minor medical conditions, whereby the program, systems, and methods dramatically reduce the cost of providing healthcare for common minor medical conditions and relieve overburdened urgent care centers and hospital emergency care facilities by reducing the patient visits for common minor medical conditions so as to allow these facilities to concentrate on medical conditions that require urgent or emergency physician care. The program, systems, and methods will make board-certified specialty physicians available for diagnostic and consultations, such as by way of a tailored medical consultation and diagnosis via online interaction with a patient, thereby addressing many healthcare needs for an individual patient, wherein the program, systems, and methods are utilizable for a variety of different medical conditions, whereby a health insurance group may pay for the consultation and diagnosis, whereby the health insurance group may pay a fee for each subscribing insured member, whereby the insured member may have access to the online medical program group by virtue of being insured by a health insurance group, whereby the health insurance group may pay a subscription fee for the ability for its insured members to utilize the system, whereby patient feedback is identifiable and collectible, and whereby the individual patients may access their medical records and may track their medication records and the like.

Various objects, features, aspects, and advantages of the present disclosure will become more apparent from the following detailed description of preferred embodiments of the disclosure, along with the accompanying drawings in which like numerals represent like components.

### BRIEF DESCRIPTION OF THE DRAWINGS

The above, and other, aspects, features, and advantages of several embodiments of the present disclosure will be more apparent from the following Detailed Description as presented in conjunction with the following several figures of the Drawing.

FIG. 1 is a block diagram illustrating an online medical system, in accordance with an embodiment of the present disclosure.

FIG. 2 is a flow diagram illustrating an online medical method of using an online medical system, in accordance with an embodiment of the present disclosure.

FIG. 3 is a flow diagram illustrating an online medical method of using an online medical system, in accordance with an alternative embodiment of the present disclosure.

While the disclosure is subject to various modifications and alternative forms, specific embodiments thereof have been shown by way of example in the drawings and will herein be described in detail. It should be understood that this disclosure is not limited to the particular forms disclosed, but on the contrary, the intention is to cover all modifications, equivalents, and alternatives falling within the spirit and scope of the disclosure.

Corresponding reference characters or reference numerals indicate corresponding components throughout the several figures of the Drawing. Elements in the several figures are illustrated for simplicity and clarity and have not necessarily been drawn to scale. For example, the dimensions of some elements in the figures may be emphasized relative to other elements for facilitating understanding of the various presently disclosed embodiments. Also, well-understood elements that are useful or necessary in commercially feasible embodiments are often not depicted in order to facilitate a less obstructed view of these various embodiments of the present disclosure.

### DETAILED DESCRIPTION

The following description is not to be taken in a limiting sense, but is made merely for the purpose of describing the general principles of exemplary embodiment of the present disclosures. The scope of the disclosure should be determined with reference to the Claims. Reference throughout this specification to “one embodiment,” “an embodiment,” or similar language means that a particular feature, structure, or characteristic that is described in connection with the embodiment is included in at least one embodiment of the present disclosure. Thus, appearances of the phrases “in one embodiment,” “in an embodiment,” and similar language throughout this specification may, but do not necessarily, all refer to the same embodiment.

Further, the described features, structures, or characteristics of the present disclosure may be combined in any suitable manner in one or more embodiments. In the Detailed Description, numerous specific details are provided for a thorough understanding of embodiments of the disclosure. That the embodiments of the present disclosure can be practiced, without one or more of the specific details, or with other methods, components, materials, and so forth is contemplated as being encompassed by the present disclosure.

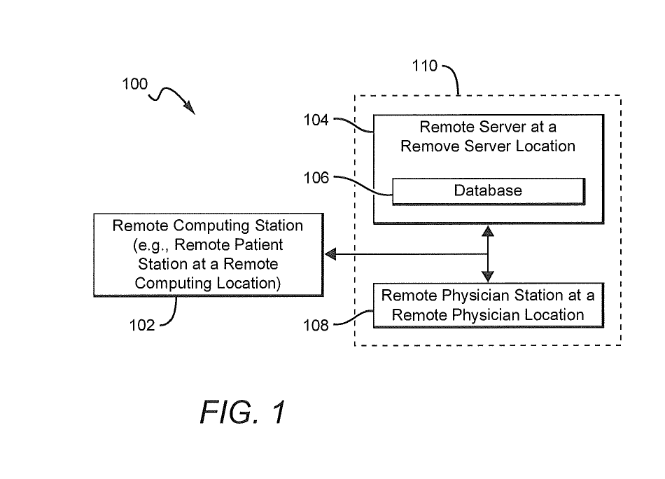

Referring to FIG. 1, this block diagram illustrates an online medical system 100, in accordance with an embodiment of the present disclosure. The example online medical system 100 comprises: a remote server 104 at a remote server location; a remote computing station 102, e.g., a remote patient station, at a remote computing location, the remote computing station 102 connected to the remote server 104; and a remote physician station 108 at a remote physician location, the remote physician station 108 connected to the remote server 104, whereby the remote computing station 102 and the remote physician station 108 are capable of communicating with one another by way of at least the remote server 104. The system 100 facilitates an individual patient in utilizing the remote computing station 102 to enter or input at least one criterion, criteria, and/or information, such as medical information, into the system 100. This information can, for example, be input into a database 106 on the remote server 104 located at a remote server location by way of the remote computing station 102. In other words, a patient might add information to the database 106 using the remote computing station 102. This information might be sent to the database 106 using a communication connection between the remote computing station 102 and the remote server 104 and the remote physician station 108. For example, a communication connection comprises the Internet. The remote server 104 can be used for storage of patient data and information in the database 106, such as the criteria entered by the patient or other data entered by a medical professional.

Still referring to FIG. 1, a physician using the remote physician station 108 can be located at a remote physician location. This location of the remote physician station 108 can be the same location as the remote server 104, as indicated by the dotted line for a common location 110. Alternatively, the location of the remote physician station 108 can be a different location from the remote server 104. The “same location” denotes the same general location, such as the same physical address. However, the same location does not necessarily denote that the physician is located in a server room, for example. The physician that receives information at the remote physician station 108 from the individual patient who is transmitting the information through the remote computing station 102 may respond through the remote server 104, whereby the information transmitted by the physician is received at the remote computing station 102.

Still referring to FIG. 1, data may flow from the remote computing station 102 to the remote server 104 and be stored in the database 106. This data flow is facilitated by using an Internet connection or other communication system, for example. Alternatively, data may flow directly from the remote computing station 102 to the remote physician station 108 by using the Internet or another communication system. Similarly, data may flow from the remote physician station 108 through the remote server 104 to the remote computing station 102 or the information may flow directly from the remote physician station 108 to the remote computing station 102. Again, the Internet or other communication system may be used. Additionally, the remote server 104 and the remote physician location 108 may have a generally common location, such as the location 110.

Still referring to FIG. 1, third-party industry products and service providers can make contact with the patient/consumer as well as physicians or other medical professionals by way of the remote server 104, such as during the diagnostic process using the system 100, in accordance with an alternative embodiment of the present disclosure. For health care delivery and diagnosis, a licensed health care professional can provide consultation and treatment by way of the system 100 comprising a program, such as a software program having a set of executable instructions for providing the interactive audio, visual, and data communication relating to potential treatment options, drug information, and educational information. The software program may be stored on the remote server 104. This information can be tailored specifically to the patient's medical issues or health history. Additionally, a patient seeking treatment by using the system 100 may use the system 100 in a live or interactive state, on-screen, and in multiple languages of the patient's choice.

Still referring to FIG. 1, some example programs of the systems 100 can provide a platform that allows for a more streamlined process of pharmacy selection that will result in targeted location selection. Such pharmacy selection may result in significant revenue opportunities for the company while providing potential cost savings to the patient/consumer. Other incremental revenue opportunities to the company while saving the patient time in the fulfillment of the prescriptions may also be available.

One example of a system 100 that allows for the opportunity to target specific advertising and to allow certain providers and manufacturers the ability to narrowly focus certain drug prescriptions and treatment protocols for patient consideration during the process of the online data collection. Additionally, some embodiments involve a software program having a set of executable instructions for suggesting pharmacies, or preferred pharmacies, in relation to post physician treatment and for providing exit instructions to the patient, such as exit instructions relating to include drug prescriptions or post diagnosed therapy options.

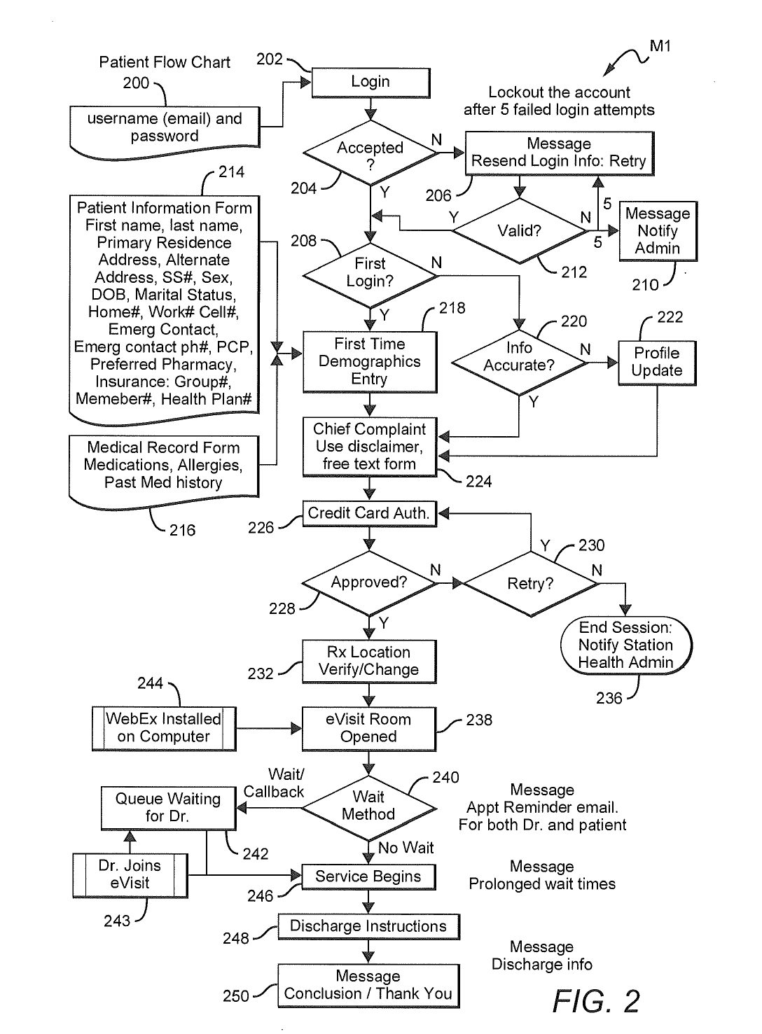

Referring to FIG. 2, this flow diagram illustrates an online medical method M1 of using an online medical system 100, such as performable by way of a set of executable instructions, in accordance with an embodiment of the present disclosure. In the illustrated embodiment, the method M1 comprises: prompting an entry of a user name and a password associated with an account, as indicated by block 200; receiving log-in information, such as an entered name and an entered password, as indicated by block 202; determining whether the log-in is successful, as indicated by block 204; if the log-in is successful, then determining whether the successful log-in comprises a first (1^{st}) log-in attempt, as indicated by block 208; and, if the log-in fails, then prompting a retry of the log-in, such as by sending a message by way of the remote server 104 to the remote computing station 102, as indicated by block 206.

Still referring to FIG. 2, the method M1 further comprises: if the successful log-in comprises a first (1^{st}) log-in attempt, then prompting an entry of demographic data, such as relating to a first-time user of the system 100, as indicated by block 218, wherein prompting the entry of the demographic data comprises: rendering a patient information form, as indicated by block 214; and rendering a medical record form, as indicated by block 216, such as on a display screen of the remote computing station 102. Step 214 of rendering the patient information form comprises prompting an entry of at least one patient information item, such as a first name, a surname, a primary residence address, a social security number (or a social insurance number), a gender indication, a birth date, a marital status, a home telephone number, a work telephone number, a mobile number, an emergency contact name, an emergency contact telephone number, e.g., an emergency contact home telephone number, an emergency contact work telephone number, an emergency contact mobile number, a primary care physician name, a preferred pharmacy name, a medical insurance group number, a medical insurance member number, a health plan number, and any other item of patient information. Step 216 of rendering the medical record form comprises prompting an entry of at least one patient medical record item, such as a medication history, an allergy history, and any other item of medical history.

Still referring to FIG. 2, the method M1 further comprises: determining whether a subsequent log-in attempt is successful (validating the subsequent log-in attempt), as indicated by block 212; if the subsequent log-in attempt is successful, then determining whether the subsequent log-in attempt in comprises a first (1^{st}) log-in attempt, as indicated by block 208; and, if the subsequent log-in attempt is unsuccessful, then determining whether the subsequent log-in attempt in comprises a fifth (5^{th}) log-in attempt, as indicated by block 208, if the subsequent log-in attempt in comprises a fifth (5^{th}) log-in attempt, then notifying a system 100 administrator and locking-out the account, as indicated by block 210, and. if the subsequent log-in attempt in comprises less than a fifth (5^{th}) log-in attempt, then re-performing step 206 of prompting a retry of the log-in, such as by sending a message by way of the remote server 104 to the remote computing station 102. If the subsequent log-in attempt in comprises is greater than a first (1^{st}) log-in attempt and less than a fifth (5^{th}) log-in attempt, the method M1 further comprises: determining whether previously entered login information, such as the username and password, is accurate, as indicated by block 220; if the previously entered login information is inaccurate, then prompting an update to an account profile, as indicated by block 222, and, if the previously entered login information is accurate, then prompting an entry of information relating to at least one medical concern, such as a chief medical complaint or symptom observed by a patient, as indicated by block 224. Step 224 further comprises rendering text for at least effecting a user disclaimer and any other text forms deemed appropriate for the practice of medicine.

Still referring to FIG. 2, the method M1 further comprises: prompting an entry of payment information, such as a credit card number and any related authorization information, such as a credit card expiration date, a credit card verification (CCV) code, and a billing address, by example only, as indicated by block 226; and determining whether payment is authorized, as indicated by block 228; if payment is authorized, then prompting a verification or a re-designation of a pharmacy, as indicated by block 232; and, if payment is denied, then prompting a re-entry of payment information, as indicated by block 230, whereby step 226 is re-performed. Credit card authorization or denial can occur in steps 226, 228, or 230. If payment is denied after a predetermined number of attempts in re-performing step 226 or if step 226 is not re-performed, such as by a user forgoing entry of payment information, the payment is respectively denied or unapproved; and a medical consultation session terminates, as indicated by block 236. However, if payment is approved, the method M1 comprises performing step 232, as above described. The method M1 further comprises at least one of: prompting downloading of application software having a set of executable instructions, such as even mobile application software, for providing a virtual visiting room or “eVisit Room,” as indicated by block 244; and providing a virtual visiting room or “eVisit Room,” wherein opening an “eVisit” Room commences a major portion of a medical consultation session, as indicated by block 238. Generally, the application software facilitates referring patients to physicians; however, the present disclosure also encompasses facilitates referring patients to other medical professionals, such as nurse-practitioners and alternative medicine service providers.

Still referring to FIG. 2, if a physician is unavailable, e.g., at the remote physician station 108, the method M1 further comprises providing a virtual waiting room or “Wait Room,” wherein opening a “Wait Room” commences a waiting period prior to the major portion of a medical consultation session, as indicated by block 240, and wherein at least one message is provided, such as a message relating to awaiting a callback from the physician, a message regarding an appointment reminder, and a message discharging information. If a physician remains unavailable, the method M1 further comprises commencing the major portion of a medical consultation session (beginning providing medical services), as indicated by block 246. However, if the physician becomes available, then the method M1 further comprises providing facilitating joining the physician with the patient, as indicated by block 243, and proceeding to step 246. In step 243, the physician makes an “eVisit.” The method M1 further comprises facilitating discharging instructions to a patient by a physician, as indicated by block 248; and transmitting a message indicating a conclusion of the medical consultation session, as indicated by block 250.

Still referring to FIG. 2, the method M1 further comprises providing messages from employers to employees in a virtual waiting room regarding treatment protocols, formulary information, and employee benefits. Additionally, some or all of this information might be made available in a multi-lingual environment. The benefits to the patient can be increased awareness of the various treatment options, possible pharmaceutical alternatives for treatment, and a reduction in the overall cost of the utilization of the platform. This increased awareness might be accomplished for at least that a potentially significant amount of the ancillary revenue being generated by the business model which is being carried out by the third party advertisers or affiliate partners. These third party advertisers or affiliate partners may subsidize part or all of the costs for the opportunity to have certain non-intrusive outreach opportunities to virtually present to the patient during the process. Some embodiments may offer a technological and regulatory compliant process that provides marketing and advertising opportunities to a directed buyer of health care needs. For example, some embodiments may provide a degree of privacy, which might be required by the Health Insurance Portability and Accountability Act (HIPPA). In an embodiment, marketing and advertising opportunities might be provided to third parties based on a medical condition while not providing specific patient information, such as patient name.

Still referring to FIG. 2, in some cases, state governments, who provide medical coverage for citizens who do not have private health insurance, as well as medical intermediaries providing or facilitating insurance coverage for private groups, specifically including Medicaid patient populations and self-insured companies who are providing coverage for their own employees, might be provided marketing and advertising opportunities that may provide revenue generation. Some embodiments allow for the monetization of various encounter opportunities between patient and physician that medical practices might not currently provide because they may be foreclosed by regulatory prohibitions, time constraints, and lack of economies of scale. An embodiment might provide the ability for the pharmaceutical industry to provide specific targeted advertising and information to physicians that they might not have access to currently. Because some embodiments are Internet based and service a large profile of patients, some example systems may be able to achieve economies of scale that might make this targeted advertising economically feasible.

Still referring to FIG. 2, in an emergency room encounter between the patient and the physician, often as much as 65% of the encounters are not true life threatening emergencies but rather inconvenient and episodic conditions that drive an Emergency Room visit due to the patient's inability of accessing a primary care physician within a reasonable time. Approximately 20% of emergency room encounters are for a narrow range of urgent and inconvenient but non-life threatening medical issues. One embodiment provides a virtual platform that is available by patient selection in multiple languages, allowing a physician and a patient to interact for urgent but non-life threatening conditions that otherwise would have resulted in the patient seeking treatment at a physical location, such as an urgent care center or Hospital Emergency Room. An example system might also provide for some aspects of non-urgent care. In some embodiments, various regulatory changes that have recently been put into effect have resulted in the inability of pharmaceutical drug companies and pharmaceutical drug manufacturers to provide previously offered educational and advertising opportunities directly to the physicians for the benefit of their patients. This has resulted in a significant improvement for the pharmaceutical industry to be able to provide timely and important product information to the medical community as was historically accomplished.

Still referring to FIG. 2, as a partial result of this new regulatory environment, many of the outreach options to the physicians by the pharmaceutical and manufacturing companies have been foreclosed. In the alternative, many of these companies have chosen to utilize more direct consumer advertising and educational messages utilizing TV, radio, Internet etc. This approach tends to have a broad range and often fails to effectively reach its target market, and even when the intended patient base is successfully reached, the message is often untimely or inconvenient for the recipient. This has created a need for an improved vehicle of communication between those offering information and education on various medical opportunities to treat disease-specific conditions between the industry and the patient on a focused and timely basis. Additionally, some embodiments provide for a business model that may offer the patient utilizing the service to not only experience a high level of convenience, but also the opportunity to be made aware of financial savings from the fulfillment of their prescription needs pursuant to their medical diagnosis. This may also provide for a high level of quality assurance relative to the integrity of the script writing process.

Still referring to FIG. 2, in some embodiments, pursuant to a patient discharge, a prescription may be written, and provided to the patient where the patient has physically visited an Emergency Room. Calling-in a prescription to a pharmacy on behalf of the patient by the emergency room physician may be unusual. This potentially results in various negative scenarios. First the patient needs to carry the prescription “in person” to the pharmacy to obtain it filled. This often results in a wait time for the prescription to be filled of a half hour to several hours for the patient. In the event the specific medication is unavailable, the patient then needs to seek out other pharmacies to fill the script resulting in even more inconvenience. Additionally, since many scripts are handwritten, there always remains the inherent risk of confusion and possible incorrect script fulfillment. When utilizing an Internet based physicians' program, this risk may be lessened or eliminated and a high level of consistency and accuracy may flow through the entire script writing and dispensing process.

Still referring to FIG. 2, the fulfillment of a script drives a consumer to the pharmacy. A tremendous amount of advertising capital is expended by pharmacies to drive consumers to fulfill their scripts at their specific stores. This is driven by the desire of the pharmacies to not only fulfill their scripts at the pharmacy, but also to encourage the consumer to purchase “non-script” related items within the pharmacy itself. Currently the pharmacy selection process has been left up to the consumer, and even when the consumer goes to a pharmacy, the consumer often goes through the “drive through” window missing any incremental product sales opportunities that could be made available by the pharmacy. Even when the consumer enters the pharmacy, he often doesn't obtain exposed to the various potential product sales or any “sale driven” advertising that is often missed or not convenient for the consumer to see.

Still referring to FIG. 2, an embodiment may offer several unique opportunities that are heretofore unavailable during the traditional script writing and fulfillment process. First, some embodiments provide for the selection of the pharmacy itself by utilizing a drop-down menu that will default to a convenient geographic location, thereby directing traffic in the common situation where the consumer doesn't have a pharmacy preference. Next, since an Internet based physician might control the pharmacy process by acting as a potential formulary on behalf of itself or a designated pharmacy partner which can be geographic specific, it has the ability to better control the costs and drug selection process in a cost effective and ethical process. This can be driven by input offered by the specific insurance carrier or self-insured plan or other formulary partner to better control costs and consistency in the absence of a “Do Not Substitute” designation by the attending physician.

Still referring to FIG. 2, additionally, during the diagnosis and discharge process, the embodiment is able to present the patient certain ancillary product purchase opportunities, that are diagnosis- or cogent-based on their medical histories that can offer the patient cost savings opportunities at pharmacies that have been identified for script fulfillment. These coupons now make the patient aware of the savings benefit, specifically targeted to their immediate issues, and incentivize the patient with a specific reason to enter the pharmacy or request these items at the time of visit to the pharmacy for their script fulfillment, which can be filled at the drive through window.

Still referring to FIG. 2, some embodiments provide a unique opportunity at several strategic points during the patient interaction to allow targeted messages in a non-obtrusive and informative manner. The virtual patient encounter can require the individual to fill out a medical questionnaire as well as provide opportunities to view and make various selections throughout the course of preparing for the virtual visit. Some embodiments may provide for the creation of a “Virtual Waiting Room™” attachment. In anticipation and preparation of the virtual medical encounter with a licensed medical health provider, the patient resides in the Internet-based physician Virtual Waiting Room™. While the patient is queuing to see the physician, this unique screen allows the patient to be presented with various informational and advertising opportunities that are all database driven and interactive. During this process, information is targeted which triggers multiple opportunities for specific advertising and educational presentations to help the patient become better informed and make better decisions about their treatment options. This engagement with the patient lasts until he/she is ready to see the attending physician.

Still referring to FIG. 2, at the time of the completion of the medical encounter, and if a prescription is part of the discharge, a drop down default screen can be structured to provide the “preferred and site recommended” pharmacy of choice for the patient, which also allows the system to provide targeted advertising and incremental marketing opportunities to the patient, also available in a printed format that the patient can print off the computer. In some embodiments, a patient might be directed to a preferred pharmacy provider. In other embodiments, a patient may select a pharmacy before a visit. Additionally, a patient may have the opportunity to change the selection of the pharmacy at a later time. The system may pre-populate the alternate selection with targeted advertising opportunities based on the selection specific to that pharmacy and its exact location. These marketing and sales opportunities may be updated on a real time basis. The script (e.g., prescription) can be electronically sent to the pharmacy and will await the patient's arrival at the pharmacy.

Still referring to FIG. 2, alternatively, in some embodiments, the script fulfillment can be accomplished by an overnight delivery service. A large number of scripts might be written for the large number of patients that might utilize the system. Accordingly, this business model may allow a company using the systems and methods described herein to negotiate revenue from various pharmacy fulfillment partners while at the same time offering superior convenience for the patient. Additional cost product savings in the form of couponing, etc. might also be made available for the patient. The couponing and various marketing materials may be placed directly on the discharge instructions as well as a separate print out that may accompany the discharge papers. There may also be coupons that can be automatically populated on the discharge instructions based on the patient profile and diagnosis.

Still referring to FIG. 2, additionally, the patient can have the opportunity to select a button that allows him or her to browse additional coupons, which may populate on additional pages. These may also be patient and diagnosis specific. This targeted advertising can be available to print. These coupons, in addition to potentially being diagnosis and/or lifestyle specific, might be time and location sensitive. All of these patient advertising and educational points of contact may result in a significant shift in the cost burden to the third party providers while still completely leaving the course of treatment to the privacy of the physician patient relationship.

Still referring to FIG. 2, contemplated is that the online virtual medical platform and complete process of interaction between the patient and the provider will be affiliated with certain third party industry product or service providers, integrated through the data collection process to provide revenue, cost savings and benefits for all parties. To this end, in an exemplary embodiment of the present disclosure of the present disclosure, online, unique key word search functionality, which is symptom, disease, and lifestyle specific, will target certain unique information display opportunities that will incorporate technology that will access current news and editorial content that will be available to the patient while awaiting the medical visit.

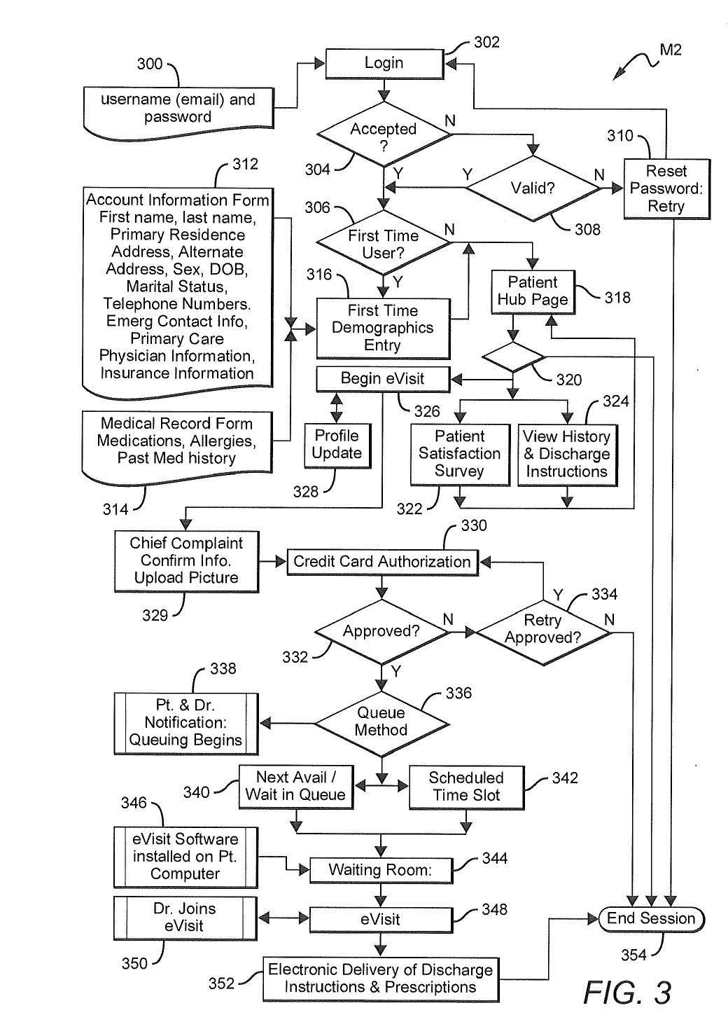

Referring to FIG. 3, this flow diagram illustrates an online medical method M2 of using an online medical system 100, such as performable by way of a set of executable instructions, in accordance with an embodiment of the present disclosure. In the illustrated embodiment, the method M2 comprises: prompting an entry of a user name and a password associated with an account, as indicated by block 300; receiving log-in information, such as an entered name and an entered password, as indicated by block 302; determining whether the log-in is successful (accepted), as indicated by block 304; if the log-in is successful, then determining whether the successful log-in comprises a first (1^{st}) log-in attempt, as indicated by block 306; and, if the log-in fails, then prompting a retry of the log-in or a reset of the password, as indicated by block 310. A patient can create a new account by: receiving an invitation email and following a link to reset the password and logging-in to an online medical system, completing an account information form, completing a medical information form, being redirected to an account hub page, and logging-out.

Still referring to FIG. 3, the method M2 further comprises: determining whether a log-in attempt indicates a return user, as indicated by block 306; if the log-in attempt indicates a return user, then rendering a patient hub page, as indicated by block 318; and, if the log-in attempt indicates a first-time user, then prompting an entry of demographic data, such as relating to a first-time user of the system 100, as indicated by block 316, wherein prompting the entry of the demographic data comprises: rendering an account information form, as indicated by block 312; and rendering a medical record form, as indicated by block 314, such as on a display screen of the remote computing station 102. Step 312 of rendering the account information form comprises prompting an entry of at least one patient information item, such as a first name, a surname, a primary residence address, a social security number (or a social insurance number), a gender indication, a birth date, a marital status, a home telephone number, a work telephone number, a mobile number, an emergency contact name, an emergency contact telephone number, e.g., an emergency contact home telephone number, an emergency contact work telephone number, an emergency contact mobile number, a primary care physician name, a preferred pharmacy name, a medical insurance group number, a medical insurance member number, a health plan number, and any other item of patient information. Step 314 of rendering the medical record form comprises prompting an entry of at least one patient medical record item, such as a medication history, an allergy history, and any other item of medical history.

Still referring to FIG. 3, the method M2 further comprises: determining information based on at least one of a patient satisfaction survey 322, a viewing history, and discharge instructions 324, or an election to begin an eVisit, as indicated by block 326, as indicated by block step 320; facilitating updating profile information by a patient or other user, as indicated by block 328. The method M2 further comprises: prompting an entry for information relating to a chief complaint for the current medical problem or problems, as indicated by block 329, wherein step 329 also comprises rendering a user disclaimer text and any other text forms appropriate for a medical practice.

Still referring to FIG. 3, the method M2 further comprises: prompting an entry of payment information, such as a credit card number and any related authorization information, such as a credit card expiration date, a credit card verification (CCV) code, and a billing address, by example only, as indicated by block 330; and determining whether payment is authorized, as indicated by block 332; if payment is authorized, then verifying approval, as indicated by block 332, wherein, if approval is verified, then proceeding to queue a session, as indicated by block 336, and wherein, if approval is not verified, then determining whether a retrying payment authorization is warranted, as indicated by block 334, and, if retrying payment is warranted, then proceeding to the queue of step 336, and, if retrying payment authorization is not warranted, then ending the session, as indicated by block 354.

Still referring to FIG. 3, once the session is queued in step 336, the method M2 further comprises: notifying the patient and the physician that the session is queued, as indicated by block 338; if next available timeslot is selected, then queuing the session for the next available timeslot, as indicated by block 340; if, a scheduled timeslot is selected, then scheduling the session for a particular timeslot, as indicated by block 342; and proceeding to a virtual waiting room, as indicated by block 344. The method M2 further comprises at least one of: prompting downloading application software having a set of executable instructions, such as even mobile application software, for providing a virtual visiting room or “eVisit Room,” as indicated by block 346; and providing a virtual visiting room or “eVisit Room,” wherein opening an “eVisit” Room commences a major portion of a medical consultation session, as indicated by block 346. Generally, the application software facilitates referring patients to physicians; however, the present disclosure also encompasses facilitates referring patients to other medical professionals, such as nurse-practitioners and alternative medicine service providers. The method M2 further comprises proceeding form the virtual waiting room of step 344 to conducting an “eVisit” by way of the “eVisit” Room software of step 346, as indicated by block 348; joining the physician with the patient in the session, as indicated by block 350; and electronically delivering and discharging instructions and prescriptions, as indicated by block 352; and ending the session, as indicated by block 354.

Still referring to FIG. 3, a patient starts an eVisit by: logging-in to an online medical system, opening an eVisit form on account hub page, reviewing the medical information and updating the medical information as needed, paying for eVisit through, e.g., a linked PayPal application or other payment method, virtually checking-in and virtually waiting for a physician, accepting a WebEx invitation from the physician, participating in a consultation with the physician, and logging-out. A patient may start an eVisit, but might not want to wait for the physician. Accordingly, the patient might (1) log in to an embodiment system, (2) patient opens eVisit form on account hub page, (3) patient reviews medical information and updates it as needed, (4) patient pays for eVisit through e.g., linked PayPal application, (5) patient checks in and asks to be notified when physician is available, and (6) patient logs out.

Still referring to FIG. 3, a patient may log in for eVisit after receiving notification. Accordingly, a patient may receive email notification, with an embedded link to a software application, stating that physician is ready for the session. The patient clicks the link in the email and is directed to a log-in page, wherein the patient logs-in, goes to account hub page, accepts invite for WebEx/phone call, participates in virtual visit, completes visit, and logs-out. In an embodiment of the method M2, after step 320, the method further comprises providing a satisfaction survey, as indicated by block 322, wherein a patient may complete the satisfaction survey, the survey providing comprising transmitting an email notification with an embedded link to a software application and advising that a patient satisfaction survey is completable by the patient, wherein the patient clicks the link in the email and is directed to log-in page, logs-in, goes to an account hub page, selects the patient satisfaction survey, completes patient satisfaction survey, and logs-out.

Still referring to FIG. 3, alternatively, a physician conducts a virtual visit without notification, including steps, such as logging-in to an online medical system, reviewing a list of patients in a queue, selecting a patient from the queue, being directed to a patient account hub page, reviewing the patient information as needed, creating a new Simple Object Access Protocol (SOAP) note, inviting patient to participate in WebEx/phone call, prescribing medications and/or medical devices, for the patient, using ePrescription application, discharging instructions to the patient (optional), completing the virtual office visit or session, and returning to the main page to review queue and selecting a next patient. For a missed patient visit, the method M2 further comprises by: transmitting an email with an embedded link to a patient account notifying a system administrator that the patient is waiting and has not been seen by a physician, contacting a physician who missed an appointment by the system administrator, if a physician who missed appointment is not available, contacting a next on-call physician by the system administrator, responding to a service request and taking-over the patient visit by a new physician, and logging-out by the new physician.

Referring back to FIGS. 2 and 3, no particular order for the steps in the methods described is required unless expressly stated and that some embodiments may use alternative orders for the steps or omit certain steps. Information as herein shown and described in detail is fully capable of attaining the above-described object of the present disclosure, the presently preferred embodiment of the present disclosure, and is, thus, representative of the subject matter which is broadly contemplated by the present disclosure. The scope of the present disclosure fully encompasses other embodiments which may become obvious to those skilled in the art, and is to be limited, accordingly, by nothing other than the appended claims, wherein any reference to an element being made in the singular is not intended to mean “one and only one” unless explicitly so stated, but rather “one or more.” All structural and functional equivalents to the elements of the above-described preferred embodiment and additional embodiments as regarded by those of ordinary skill in the art are hereby expressly incorporated by reference and are intended to be encompassed by the present claims.

Moreover, no requirement exists for a system or method to address each and every problem sought to be resolved by the present disclosure, for such to be encompassed by the present claims. Furthermore, no element, component, or method step in the present disclosure is intended to be dedicated to the public regardless of whether the element, component, or method step is explicitly recited in the claims. However, that various changes and modifications in form, material, work-piece, and fabrication material detail may be made, without departing from the spirit and scope of the present disclosure, as set forth in the appended claims, as may be apparent to those of ordinary skill in the art, are also encompassed by the present disclosure.

What is claimed:

1. An online medical system, the system comprising:
at least one database storable in relation to at least one remote server, the at least one database capable of storing at least one of patient information and physician information, the patient information comprising at least one of patient data, patient medical records, and patient input criteria, and the physician information comprising at least one of physician data, physician track records, physician feedback, and physician orders; and
at least one set of executable instructions storable in relation to the at least one remote server and operable in relation to the at least one database, the at least one remote server disposed in relation to at least one remote server location, and the at least one set of executable instructions capable of facilitating a virtual medical consultation.

2. The system of claim 1:
wherein the at least one set of executable instructions facilitates communication between the at least one remote server and at least one of at least one remote patient and at least one remote physician; and
wherein the at least one set of executable instructions facilitates communication between the at least one remote patient and the at least one remote physician.

3. The system of claim 2, wherein the at least one remote server is capable of communicating with at least one remote patient station disposed in relation to at least one remote patient location, the at least one remote patient station adapted to receive, process, and transmit the patient information to the at least one remote server.

4. The system of claim 2, wherein the at least one remote server is capable of communicating with at least one remote physician station for facilitating communication by the at least one remote physician disposed in relation to at least one remote physician location for facilitating communication by the at least one remote physician with the remote server, the at least one remote physician station adapted to receive the patient information and to transmit at least one discharge instruction and at least one prescription.

5. The system of claim 1, wherein the physician feedback comprises information relating to at least one of a diagnosis, a prognosis, a treatment plan, a pharmaceutical prescription, an over-the-counter prescription, a medical device prescription, a medical equipment prescription, and a health enhancement prescription.

6. The system of claim 1, wherein the database is further capable of maintaining at least one of the patient information and the physician information.

7. The system of claim 1, wherein the set of executable instructions facilitates communication via at least one mode of an interactive audio mode, a visual mode, any electronic mode, and any digital mode.

8. The system of claim 1, wherein the set of executable instructions facilitates payment for a consultation by at least one source of the at least one remote patient, at least one health insurance provider, at least one parent, and at least one guardian.

10. The system of claim 1, wherein the physician orders comprises at least one of a radiology order, a laboratory test order, and a monitoring order specific to the at least one remote patient.

11. The system of claim 10, wherein the radiology order comprises at least one of an order X-ray order, an MRI scan order, and a CT Scan order.

12. The system of claim 1, wherein the set of executable instructions facilitates transmitting the patient information from the at least one database to a primary care physician.

13. The system of claim 1, wherein the set of executable instructions facilitates providing a follow-up virtual consultation.

14. The system of claim 1, wherein the remote server location and the remote physician location comprise substantially a same location.

15. The system of claim 1, further comprising:
wherein the at least one set of executable instructions facilitates communication between the at least one remote server and at least one of at least one remote patient and at least one remote physician;
wherein the at least one set of executable instructions facilitates communication between the at least one remote patient and the at least one remote physician;
wherein the at least one remote server is capable of communicating with at least one remote patient station disposed in relation to at least one remote patient location, the at least one remote patient station adapted to receive, process, and transmit the patient information to the at least one remote server;
wherein the at least one remote server is capable of communicating with at least one remote physician station for facilitating communication by the at least one remote physician disposed in relation to at least one remote physician location for facilitating communication by the at least one remote physician with the remote server, the at least one remote physician station adapted to receive the patient information and to transmit at least one discharge instruction and at least one prescription;
wherein the physician feedback comprises information relating to at least one of a diagnosis, a prognosis, a treatment plan, a pharmaceutical prescription, an over-the-counter prescription, a medical device prescription, a medical equipment prescription, and a health enhancement prescription;
wherein the database is further capable of maintaining at least one of the patient information and the physician information;
wherein the set of executable instructions facilitates communication via at least one mode of an interactive audio mode, a visual mode, any electronic mode, and any digital mode;
wherein the set of executable instructions facilitates payment for a consultation by at least one source of the at least one remote patient, at least one health insurance provider, at least one parent, and at least one guardian;
wherein the physician orders comprises at least one of a radiology order, a laboratory test order, and a monitoring order specific to the at least one remote patient;
wherein the radiology order comprises at least one of an order X-ray order, an MRI scan order, and a CT Scan order;
wherein the set of executable instructions facilitates transmitting the patient information from the at least one database to a primary care physician;
wherein the set of executable instructions facilitates providing a follow-up virtual consultation; and
wherein the remote server location and the remote physician location comprise substantially a same location.

16. A method of providing an online medical system, the method comprising;
providing at least one database storable in relation to at least one remote server, the database providing comprising providing the at least one database as capable of storing at least one of patient information and physician information, the patient information comprising at least one of patient data, patient medical records, and patient input criteria, and the physician information comprising at least one of physician data, physician track records, physician feedback, and physician orders; and
providing at least one set of executable instructions storable in relation to the at least one remote server and operable in relation to the at least one database, the at least one remote server disposed in relation to at least one remote server location, and the at least one set of executable instructions capable of facilitating a virtual medical consultation.

17. The method of claim 16;
wherein providing the at least one set of executable instructions comprises providing the at least one set of executable instructions as capable of facilitating communication between the at least one remote server and at least one of at least one remote patient and at least one remote physician; and
wherein providing the at least one set of executable instructions comprises providing the at least one set of executable instructions as capable of facilitating communication between the at least one remote patient and the at least one remote physician.

18. A method of virtually consulting by way of an online medical system, the method comprising:
providing the online medical system, the system providing comprising:
providing at least one database storable in relation to at least one remote server, the database providing comprising providing the at least one database as capable of storing at least one of patient information and physician information, the patient information comprising at least one of patient data, patient medical records, and patient input criteria, and the physician information comprising at least one of physician data, physician track records, physician feedback, and physician orders; and
providing at least one set of executable instructions storable in relation to the at least one remote server and operable in relation to the at least one database, the at least one remote server disposed in relation to at least one remote server location, and the at least one set of executable instructions capable of facilitating a virtual medical consultation;
prompting an entry of log-in information;
receiving log-in information;
determining whether a log-in is successful, and if the log-in is successful; prompting an entry of demographic data relating to the at least one patient by rendering a patient information form and a medical record form; and
prompting an entry of information relating to at least one medical concern.

19. The method of claim 18, further comprising:
prompting an entry of payment information; and
determining whether payment is authorized.

20. The method of claim 18, further comprising:
providing a virtual waiting room;
joining the at least one remote physician by way of at least one remote physician station with the at least one remote patient by way of at least one remote patient station;
conducting a virtual office visit;
providing at least one of the physician feedback and the physician orders; and
transmitting a message indicating a conclusion of the virtual consultation session.
